(19) United States
(12) Patent Application Publication
(10) Pub. No.: US 2005/0213606 A1
(43) Pub. Date: Sep. 29, 2005

(54) Method of triggering application service using response filter criteria and IP multimedia subsystem using the same

(76) Inventors: Jiun-Yao Huang, Nantou City (TW); Wei-Kuo Chiang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/809,834

(22) Filed: Mar. 25, 2004

(51) Int. Cl. H04L 12/28

(52) U.S. Cl. 370/467

(57) ABSTRACT

A triggering method for IP multimedia service control. The triggering method comprises examining a SIP response message received by a S-CSCF according to a set of response Filter Criteria (rFC), and subsequently recording a corresponding SIP request message and re-issuing the SIP request message to an application server designated by the rFC if the SIP response message matches the Service Point Triggers (SPTs) of the rFC. The S-CSCF examines the SPTs of the rFC one by one according to their indicated priority. The rFC scheme is useful when the application servers are triggered according to the SIP response message, and is compatible with the iFC scheme. The rFC scheme of the present invention improves the efficiency for call establishment as well as improving the flexibility of the S-CSCF.

### BACKGROUND OF THE INVENTION

1. Field of the Invention

The present invention relates to an IP multimedia subsystem, and more specifically, to use of specific Filter Criteria to trigger an application server according to the SIP response.

2. Description of the Related Art

FIG. 1 illustrates an example of the architecture of a 3GPP (Third Generation Partnership Project) IP (Internet Protocol) multimedia subsystem. FIG. 1 demonstrates a visited network 10, home network 11, and external network 12. As shown in the diagram, User Equipment (UE) 101 in the visited network connects to the General Packet Radio Service (GPRS) system 102 through a 3G/UMTS communication network. There is a Proxy Call Session Control Function (P-CSCF) 103 in the visited network for communication with an Interrogating CSCF 111 (I-CSCF) and a Serving CSCF (S-CSCF) 112 in the home network 11. The Home Subscriber Server (HSS) 113 stores subscriber-related information and service-related data for the S-CSCF 112, I-CSCF 111, and application servers 114. The service-related data is transparent to the HSS 113, thus the HSS 113 has some means to differentiate the source of the request for the data, so it is able to respond with the requested data. The Multimedia Resource Function (MRF) 115 comprises a Multimedia Resource Function Controller (MRFC) and Multimedia Resource Function Processor (MRFP). The application servers can interact with the MRFC via the S-CSCF to control Multimedia Resource Function (MRF) processing. The S-CSCF 112 communicates to the application servers 114 via the IP multimedia service control (ISC) interface. The application servers 114 can be Session Initiation Protocol (SIP) application servers, Open Service Access (OSA) service capability server (OSA SCS), and others. As shown in the diagram, the computer 121 and Voice over IP (VoIP) phone 122 in the external network 12 are connected to the rest of the IP multimedia subsystem via the Internet.

FIG. 2 illustrates an example of call setup in the 3GPP IP multimedia subsystem. An originating UE 201 sends an SIP message to the radio access network 202 of the local (either visited or home) network 20 to initiate a call with a terminating UE 235. The radio access network 202 passes the request to the Serving GPRS Support Node (SGSN) 203, Gateway GPRS Support Node (GGSN) 204, and P-CSCF 205. The P-CSCF 205 then forwards the SIP message to the S-CSCF 211 of the originating home network 21. The ISC interface of the 3GP IP Multimedia Subsystem (IMS) regulates a Filter Criteria (FC) mechanism. FC defines the relevant Service Point Triggers (SPTs) for each application. When the S-CSCF 211 receives the SIP message, it examines the SIP requests according to the SPTs of the FC, in order to determine where to send/proxy the SIP message. The S-CSCF 211 may send the SIP message to the application server 212, and after performing the service provided by the application server 212, the SIP message is forwarded to the I-CSCF 221 of the terminating home network 22. The I-CSCF 221 requests information from its HSS 222 then passes to S-CSCF 223. The S-CSCF 223 of the terminating home network 22 checks the SPTs and proxies the SIP message to the matched application server 224. The P-CSCF 231 of the network 23 is connected to receive the SIP message, forwarded to the GGSN 232, SGSN 233, radio access network 234, and finally to the terminating UE 235.

The standard FC defined by 3GPP performs filtering for initial SIP request messages only, referred to as initial Filter Criteria (iFC). FIG. 3 illustrates the trigger mechanism for IP multimedia service control using the iFC. The S-CSCF 31 applies iFC to determine the need to forward SIP requests to the corresponding application servers when a user sends an SIP initial request. The iFC are stored in the HSS 33 as part of the user profile and downloaded to the S-CSCF 31 upon user registration, or upon a terminating initial request for an unregistered user if unavailable. The iFC represents a provisioned subscription of a user to an application. The iFC are valid throughout the registration lifetime of a user or until the user profile is changed.

The S-CSCF 31 first requests the relevant set of iFCs from the HSS 33 that applies to the end user. When the S-CSCF 31 receives the SIP initial request, it determines whether the SIP request matches with iFC X according to the SPTs. The SIP request is forwarded to the first application server (AS1) 32 if it matches with iFC X. The SIP interface 321 receives the SIP request and executes the relevant service logic 322 according to the service key iFC X. The service logic 322 of the AS1 32 may modify the SIP request, and then the SIP message is sent back to the S-CSCF 31. The S-CSCF 31 also examines whether the SPTs matches the iFC Y, and if they match, the SIP request is sent to the second application server (AS2) 34. Similarly, the AS2 34 receives the SIP request from the SIP interface 341, executes the service logic 342 within AS2 34, and sends back the SIP message to the S-CSCF 31. If no more (or none) of the iFC apply, the S-CSCF 31 forwards this SIP request downstream based on the route decision. In any instance, if the contact of the application server fails, the S-CSCF 31 uses the “default handling” associated with the iFC to determine if it shall either terminate the call or let the call continue based on the information in the iFC.

The 3GPP only defines the initial Filter Criteria (iFC) triggering mechanism triggered by the SIP request, which means all the service calls matched with iFC need to be forward to the application servers in order to have the ability of handling the service. However some services are activated by the SIP response instead of the SIP request, for example, the service of call forwarding on busy. The S-CSCF requires transferring the SIP request to the application server for call forwarding on busy even the terminating UE is not busy. The decision of triggering these application servers cannot be determined by the SIP request, thus sending the SIP request to these application servers is unnecessary. Large amount of unnecessary SIP messages transmitted between the S-CSCF and the application servers wastes the resource and causes system delay.

### SUMMARY OF THE INVENTION

Accordingly, the object of the present invention is to reduce the number of unnecessary SIP message relay, in order to improve the efficiency of establishing session calls.

Another object of the present invention is to simplify the operational configuration of the service-related application servers from back-to-back user agent (UA) to terminating UA.

Yet another object of the present invention is to provide a flexible multimedia service control capability to the S-CSCF.

In order to achieve these objects, the present invention provides a triggering method for IP multimedia service control using response Filter Criteria (rFC). The response Filter Criteria defines a set of Service Point Triggers (SPTs) such that the S-CSCF triggers an application server according to the response message. The triggering method disclosed in the present invention comprises examining a Session Initial Protocol (SIP) response message received by a Serving Call Session Control Function (S-CSCF) according to a set of response Filter Criterias (rFCs), subsequently recording a corresponding SIP request message, and if the SIP response message matches the Service Point Triggers (SPTs) of one of the rFCs, then re-issuing the SIP request message to the corresponding application server designated by the matched rFC. The SPTs of a rFC are defined by: SIP response codes, SIP method of the corresponding SIP request message, content of any header field or request-URI of the corresponding SIP request message, and direction of the corresponding SIP request message. The S-CSCF examines the SPTs of the rFC one by one according to their indicated priority.

The present invention uses the rFC mechanism to improve the originally triggering mechanism. The rFC mechanism can coexist with the iFC (initial Filter Criteria) mechanism as these two mechanisms are compatible. The S-CSCF has the ability to disable or enable the rFC mechanism, and when the rFC mechanism is disabled, it is the same as the standard triggering mechanism disclosed in 3GPP.

The storing location, data format, download timing, and matching manner of the rFC are identical to the iFC defined in the 3GPP IP Multimedia Subsystem (IMS) IP multimedia Service Control (ISC). The rFC are stored in a Home Subscriber Server (HSS) as part of the user profile, and downloaded to the S-CSCF upon user registration.

The application server can be an SIP application server, Internet Protocol (IP) Multimedia Service Switching Function (IP-SSF), Open Service Access (OSA) Service Capability Server (SCS), and etc. The present invention is applied when the application servers are selected depending on the SIP response message, for examples when the call receiver is busy, unreachable or not found, or when the call setup is failed.

The present invention also provides an IP multimedia subsystem to perform the triggering method, wherein the IP multimedia subsystem comprises an S-CSCF, application server, and HSS. The S-CSCF receives and checks the SIP response message, and forwards the corresponding SIP request message to the application server if the SIP response message matches the SPTs of the rFC. The rFC are stored in the HSS, and downloaded to the S-CSCF for matching.

### BRIEF DESCRIPTION OF THE DRAWINGS

The present invention can be more fully understood by reading the subsequent detailed description in conjunction with the examples and references made to the accompanying drawings, wherein:

FIG. 1 illustrates the network configuration of the 3GPP IP multimedia subsystem;

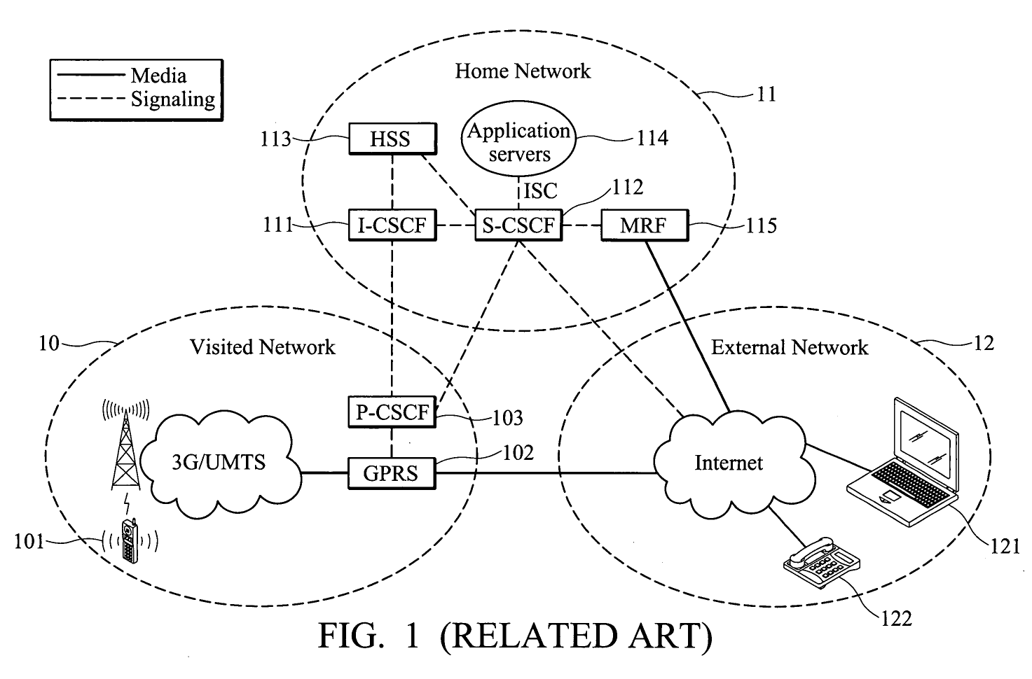

FIG. 2 illustrates the call setup procedures in the 3GPP IP multimedia subsystem;

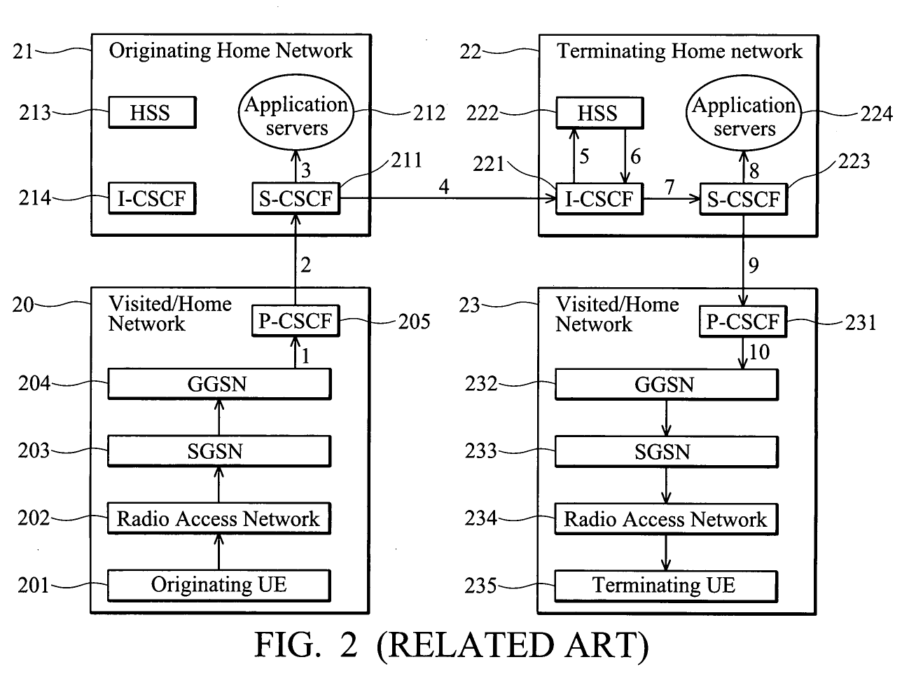

FIG. 3 illustrates the application triggering architecture according to the initial Filter Criteria (iFC) scheme;

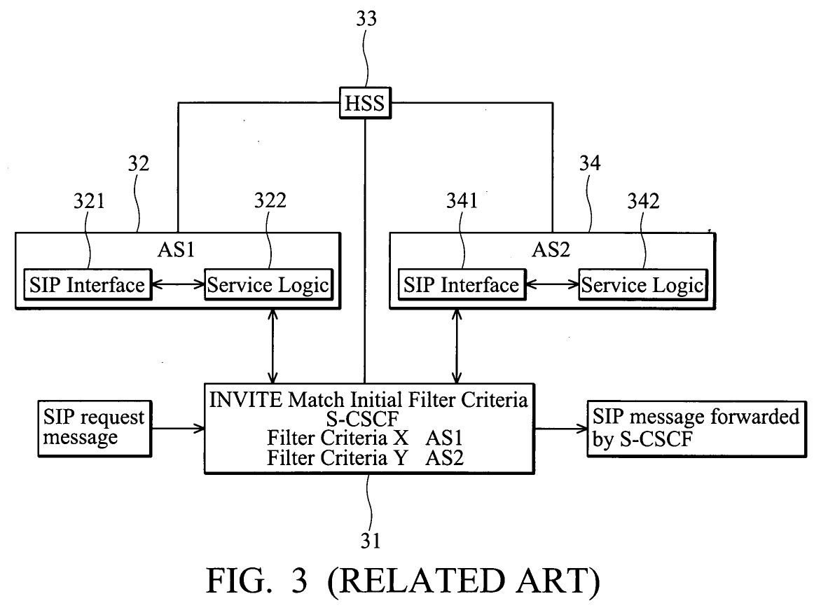

FIG. 4a illustrates an SIP message flow chart in the situation of call forwarding to a voice mail when the terminating UE (UE2) is busy (rFC scheme not involved);

FIG. 4b illustrates an SIP message flow chart in the situation of call forwarding to a voice mail when the terminating UE (UE2) is busy (rFC scheme involved);

FIG. 5 illustrates the UML model of the service point of trigger (SPT) in the response Filter Criteria (rFC).

### DETAILED DESCRIPTION OF THE INVENTION

The following description is based on an example of call forwarding.

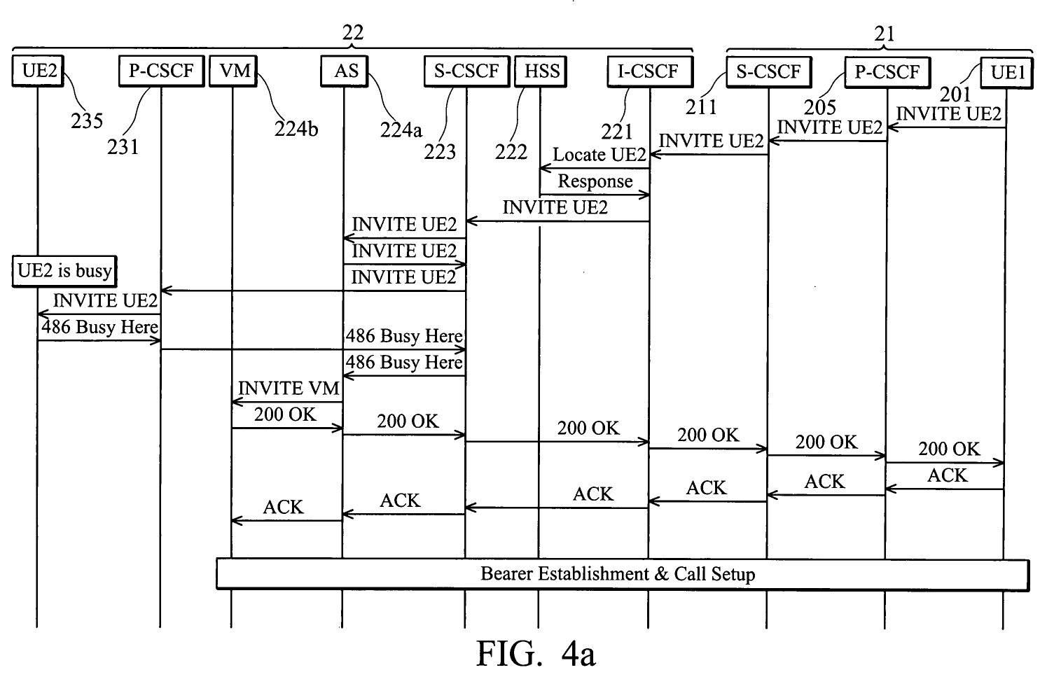

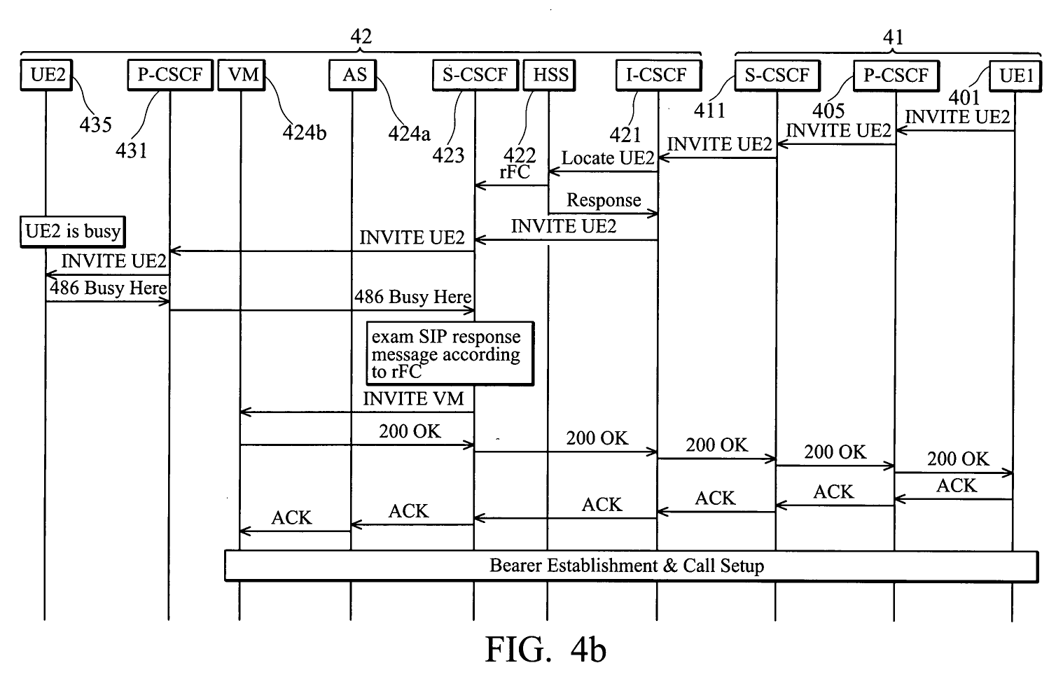

FIGS. 4a and 4b illustrate the SIP message flowing chart in the case of call forwarding to a voice mail when the terminating UE (UE2) is busy. FIG. 4a shows the IP multimedia subsystem without the rFC scheme, whereas FIG. 4b shows the IP multimedia subsystem with the rFC scheme disclosed in the present invention.

As shown in FIG. 4a, the originating user equipment (UE1) 201 originates an SIP invite message according to the standard 3GPP IMS to request a call establishment with the terminating user equipment (UE2) 235. The SIP invite message passes from UE1 201 to the P-CSCF 205 and S-CSCF 211 of UE1's home network 21, then further passes to the I-CSCF 221 and HSS 222 of UE2's home network 22. HSS 222 then sends back the location information of the UE2 235 to the I-CSCF 221, so the I-CSCF 221 is able to pass the SIP invite message to the S-CSCF 223 of UE2's home network 22. The S-CSCF 223 checks the SIP invite message with the iFC, and forwards the SIP invite message to an application server (AS) 224a once the SIP invite message matches the iFC. Accordingly, the AS 224a tries to establish a call to UE2 235 via the S-CSCF 223 and P-CSCF 231. Unfortunately, UE2 235 is busy at the moment, thus it responds an SIP response message of “486 busy here” to the AS 224a via the same path. The AS 224a establishes a call to a Voice Mail (VM) server 224b if the user profile of UE2 235 includes a voice mail service. The VM server 224b replies an SIP response message of “200 OK” to the AS 224a to agree the call setup between UE1 201 and the VM server 224b. Notice that the VM server 224b is also an application server, but it is a terminating application rather than a back-to-back application server.

FIG. 4b illustrates the same situation as shown in FIG. 4a, thus the message flowing procedures are identical until the S-CSCF 423 of UE2's home network 42 receives the SIP invite message from the I-CSCF 421. The S-CSCF 423 forwards the SIP invite message to UE2 435 via the P-CSCF 431 without going through the AS 424a. UE2 435 is currently busy, and therefore the S-CSCF 423 receives an SIP response message of “486 busy here” via the P-CSCF 431. The S-CSCF 423 sends an invite message to the VM server 424b as the SIP response message “486 busy here” matches the Service Point Triggers (SPTs) of the rFC. The VM server 424b responds with “200 OK” to the S-CSCF 423 to initiate setting up the communication between UE1 401 and the VM server 424b.

While comparing FIGS. 4a and 4b, the IP multimedia subsystem requires less exchange of SIP messages if employing the rFC scheme for triggering the application servers according to the SIP response messages. By reducing the total number of SIP messages flowing between entities, the efficiency of call setup is improved thereof. The load of the application servers is also reduced, as the application servers of prior art perform back-to-back service, whereas most application servers are just terminating application servers if the rFC scheme of the present invention is used. The terminating application servers do not require the ability of message determination and transferring, and there are less traffic flowing to the terminating application servers.

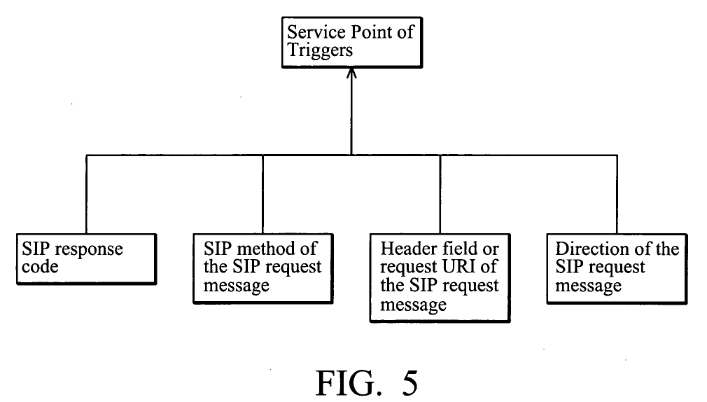

The S-CSCF downloads the rFC from the HSS, and the service point of triggers (SPTs) is illustrated using the UML model shown in FIG. 5. The SPTs are defined by SIP response code, SIP method of the corresponding SIP request message, content of the header field or request URI of the corresponding SIP request message, and the direction of the corresponding SIP request message.

The rFC scheme can be employed with the original iFC scheme simultaneously to enhance the triggering mechanism for IP multimedia service control. The S-CSCF becomes more flexible because both the SIP request message and the SIP response message may trigger the services provided by the application servers.

When implementing the triggering method of the present invention, the S-CSCF requires the ability of processing the rFC, and the HSS requires additional rFC data, so it can be downloaded to the S-CSCF upon request. The FC data is stored as XML script format, wherein SML script has the characteristic of self-describable, thus it is easy to extend.

Finally, while the invention has been described by way of example and in terms of the above, it is to be understood that the invention is not limited to the disclosed embodiment. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A triggering method for IP multimedia service control, comprising the steps of:
examining a Session Initial Protocol (SIP) response message received by a Serving Call Session Control Function (S-CSCF) according to a set of response Filter Criteria (rFC), comprising specific responses triggering individual application services available from a service provider; and
re-issuing a corresponding SIP request message to an application server designated by the rFC if the SIP response message matches Service Point Triggers (SPTs) of the rFC.

2. The triggering method according to claim 1, further comprising setting up a list of SPTs of the rFC for matching the SIP response message.

3. The triggering method according to claim 2, wherein the SPTs of the rFC are defined by:
SIP response code;
an SIP method of the corresponding SIP request message;
a content of a header field or request-URI of the corresponding SIP request message; and
a direction of the corresponding SIP request message.

4. The triggering method according to claim 1, wherein the S-CSCF examines the SPTs of the rFC one by one according to their indicated priority.

5. The triggering method according to claim 1, further comprising recording the SIP request message when the SIP response message matches the SPTs of the rFC.

6. The triggering method according to claim 1, further comprising the steps of:
examining an SIP request message received by the S-CSCF according to a set of initial Filter Criteria (iFC); and
re-issuing the SIP request message to an application server designated by the iFC if the SIP request message matches Service Point Triggers (SPTs) the iFC.

7. The triggering method according to claim 6, wherein the S-CSCF examines the SPTs of the rFC or iFC one by one according to their indicated priority.

8. The triggering method according to claim 1, wherein the rFC are stored in a Home Subscriber Server (HSS) as part of the user profile.

9. The triggering method according to claim 1, wherein the rFC are downloaded to the S-CSCF upon user registration.

10. The triggering method according to claim 1, wherein the application server is an SIP application server.

11. The triggering method according to claim 1, wherein the application server is an Internet Protocol (IP) Multimedia Service Switching Function (IP-SSF).

12. The triggering method according to claim 1, wherein the application server is an Open Service Access (OSA) Service Capability Server (SCS).

13. The triggering method according to claim 1, wherein the triggering method is applied when the application servers are selected depending on a content of the SIP response message.

14. The triggering method according to claim 13, wherein the SIP response message represents a connection status is line busy.

15. The triggering method according to claim 13, wherein the SIP response message represents a connection status of destination unreachable or not found.

16. The triggering method according to claim 13, wherein the SIP response message represents a connection status of call setup failure.

17. An Internet Protocol (IP) multimedia subsystem, comprising:
a Serving Call Session Control Function (S-CSCF), receiving a Session Initial Protocol (SIP) response message, examining the SIP response message according to a set of response Filter Criteria (rFC), comprising specific responses triggering individual application services available from a service provider; and
an application server, receiving a corresponding SIP request message from the S-CSCF if Service Point Triggers (SPTs) of the rFC matches the SIP response message.

18. The IP multimedia subsystem according to claim 17, wherein the SPTs of the rFC are defined by:
SIP response codes;
an SIP method of the corresponding SIP request message;
a content of any header field or request-URI of the corresponding SIP request message; and
a direction of the corresponding SIP request message.

19. The IP multimedia subsystem according to claim 17, wherein the S-CSCF examines the SPTs of the rFC one by one according to their indicated priority.

20. The IP multimedia subsystem according to claim 17, wherein the S-CSCF records the corresponding SIP request message when the SIP response message matches the SPTs of the rFC.

21. The IP multimedia subsystem according to claim 17, wherein the S-CSCF examines an SIP request message received by the S-CSCF according to a set of initial Filter Criteria (iFC) and re-issuing the SIP request message to an application server designated by the iFC if the SIP request message matches Service Point Triggers (SPTs) of the iFC.

22. The IP multimedia subsystem according to claim 21, wherein the S-CSCF examines the SPTs of the rFC or iFC one by one according to their indicated priority.

23. The IP multimedia subsystem according to claim 21, wherein the S-CSCF selectively disables the function of examining the rFC.

24. The IP multimedia subsystem according to claim 17, further comprising a Home Subscriber Server (HSS) for storing the rFC as part of the user profile.

25. The IP multimedia subsystem according to claim 17, wherein the rFC are downloaded to the S-CSCF upon user registration.

26. The IP multimedia subsystem according to claim 17, wherein the application server is an SIP application server.

27. The IP multimedia subsystem according to claim 17, wherein the application server is an Internet Protocol (IP) Multimedia Service Switching Function (IP-SSF).

28. The IP multimedia subsystem according to claim 17, wherein the application server is an Open Service Access (OSA) Service Capability Server (SCS).

29. The IP multimedia subsystem according to claim 17, wherein the application servers are selected depending on a content of the SIP response message.

30. The IP multimedia subsystem according to claim 29, wherein the SIP response message represents a connection status of line busy.

31. The IP multimedia subsystem according to claim 29, wherein the SIP response message represents a connection status of destination unreachable or not found.

32. The IP multimedia subsystem according to claim 29, wherein the SIP response message represents a connection status of call setup failure.
